(19) United States
(12) Patent Application Publication
(10) Pub. No.: US 2026/0220364 A1
(43) Pub. Date: Jul. 30, 2026

(54) MACHINE LEARNING BASED GENERATION OF LINGUISTICALLY CALIBRATED OUTPUTS

(71) Applicant: INTUIT INC., Mountain View, CA (US)

(72) Inventor: Aram MARTIROSYAN, Agoura Hills, CA (US)

(21) Appl. No.: 19/041,353

(22) Filed: Jan. 30, 2025

(51) Int. Cl. G06F 40/263

(52) U.S. Cl. CPC G06F 40/263

(57) ABSTRACT

Aspects of the present disclosure relate to generating linguistically calibrated outputs in machine learning models. Embodiments include detecting, by a machine learning model, a native language of a user based on one or more inputs in a target language. Embodiments further include determining, by the machine learning model, a social distance score for the native language relative to the target language if a probability associated with the native language is above a threshold value. Embodiments further include generating, by the machine learning model, a calibrated response to the one or more inputs based on analyzing the social distance score, wherein the calibrated response is in the target language. Embodiments further include providing, by the machine learning model, the calibrated response as an output.

### INTRODUCTION

Aspects of the present disclosure relate to techniques for generating linguistically calibrated outputs in machine learning models. In particular, techniques described herein involve using a machine learning model to detect a user's native language, calculate a social distance score based on comparing the native language to a target language, and generate a response in the target language calibrated to the user's native language.

### BACKGROUND

Every year, millions of people, businesses, and organizations around the world use software applications to assist with countless aspects of life. The use of machine learning models, including language processing machine learning models, in software applications has become widespread. One of those many uses may include generating responses to one or more inputs provided to the machine learning model. With both business and personal transactions occurring on a global scale, communication across numerous countries and amongst multiple languages has grown increasingly common. Due to significant variation across languages, even communicating in a single language, for example English, can result in errors and/or confusion when it is not an individual's first language. Additionally, even small misunderstandings can result in significant ramifications.

Existing techniques do not address the aforementioned shortcomings when generating responses using machine learning models. Thus, there is a need in the art for improved techniques for generating responses to user inputs using machine learning models.

### BRIEF SUMMARY

Certain embodiments provide a method of generating linguistically calibrated outputs in machine learning models. The method generally includes: detecting, by a machine learning model, a native language of a user based on one or more inputs in a target language; determining, by the machine learning model, a social distance score for the native language relative to the target language if a probability associated with the native language is above a threshold value; generating, by the machine learning model, a calibrated response to the one or more inputs based on analyzing the social distance score, wherein the calibrated response is in the target language; and providing, by the machine learning model, the calibrated response as an output.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of workflow related to generating linguistically calibrated outputs in machine learning models.

FIG. 2 is an additional example of workflow related to generating linguistically calibrated outputs in machine learning models.

FIG. 3 is a block diagram illustrating an example related to generating linguistically calibrated outputs in machine learning models.

FIG. 4 depicts example operations related to generating linguistically calibrated outputs in machine learning models.

FIG. 5 depicts an example of a processing system for generating linguistically calibrated outputs in machine learning models.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating linguistically calibrated outputs in machine learning models.

In order to improve output response generation in machine learning models, techniques described herein automatically detect a user's native language from an input in a target language and generate a calibrated response based on analyzing a social distance score associated with the native language (i.e., based on certain attributes of the native language such as linguistic characteristics, cultural distinctions, and/or the like). First, a machine learning model, such as a language processing machine learning model, may detect a native language of a user based on one or more inputs in a target language. For example, the language processing machine learning model may be a large language model capable of processing natural language inputs and generating natural language outputs. The native language may be a language different than the target language, and/or may include a dialect, and/or may be a hybrid language. When the native language is detected, a probability score associated with the native language may also be generated by the machine learning model. If the probability score is above a threshold value (i.e., exceeds a required level of certainty that the language detected is the native language of the user), then the machine learning model may determine a social distance score for the native language relative to the target language.

The determining of the social distance score may include comparing one or more attributes associated with the native language to a baseline set of attributes associated with the target language. For example, the social distance score may take into account geographical and/or cultural proximities between the native language and the target language, historical relationships between the languages, linguistic similarities between the languages, or a combination thereof. A higher social distance score may indicate that the native language differs greatly from the target language while a lower social distance score may indicate that there are a significant amount of similarities between the two languages.

Then, based on analyzing the social distance score, the machine learning model may generate a calibrated response to the one or more inputs, wherein the calibrated response is in the target language. Generating the calibrated response may comprise generating a response to the one or more inputs and altering one or more aspects of the response according to characteristics associated with the native language to produce the calibrated response. For example, the machine learning model may create a generic response based on the content of the inputs and then edit it to exclude an idiom that is commonly used in English but may not be understood by a user whose first language is not English. Other potential alterations could include technical terminology simplification, politeness expectations, analogies, other style adjustments, and/or the like. Alternatively, rather than generating a response and then altering it, the machine learning model may directly generate the calibrated response having such tailored attributes based on the characteristics associated with the native language. In either case, each response may be specially calibrated to meet the linguistic background of a particular user. Responses calibrated to the linguistic background of a user will tend to increase familiarity (e.g., a user is more comfortable with the particular syntax in the calibrated response) as well as reduce awkwardness and the chance of misunderstandings, ultimately improving the effectiveness of the communication as the user is able to more clearly understand the subject matter of such communication. The calibrated response may then be provided as an output by the machine learning model.

Additionally, an action may be performed based on the output. For example, actions may include displaying the output via a user interface, sending the output to one or more elements of a software application, or both.

Embodiments of the present disclosure provide numerous technical and practical effects and benefits. Current techniques for response generation in machine learning models do not take into account a user's native language nor do they tailor responses based on particular linguistic attributes associated with that native language. This can result in errors and confusion as well as increased costs associated with time and computing resources required to potentially check, alter, and/or clarify communications generated by a machine learning model. Embodiments of the present disclosure solve these technical problems. Techniques described herein ensure improved communication quality and effectiveness by automatically detecting a native language of a user and using a social distance score based on certain attributes of the native language to generate a response calibrated to the user's linguistic style. Notably, a machine learning model is not being implemented to translate an input from one language to another but rather is detecting a different, native language of a user (e.g., a user's first language that is not the same as the language of the input) from an input that is in a target language. In an example, the user is a native French speaker and provides an input in English. The machine learning model may detect from the English input that the user is a native French speaker based on analyzing, for instance, certain linguistic characteristics of the input. No prior knowledge or sample from the user or of their native language is required. Furthermore, the machine learning model then automatically formulates a response in the target language calibrated to the native language by adjusting one or more parameters based on, for instance, cultural or grammatical attributes associated with the native language. Continuing the example, the machine learning model may, before outputting the English response, alter sentence structure and remove an idiom that may not be well understood in French culture but is used commonly in English. This results in more useful automatically generated responses better suited for each user and ultimately provides more efficiency in communication across an extensive range of geographic regions and demographic classifications than would be possible using existing machine learning based techniques. The system may also have built-in checks, such as automatically generating and analyzing a probability score, to ensure accuracy in detecting the native language and generating the most accurate response, potentially saving large amounts of computing resources that are often associated with reproducing an alternative output or further processing and/or correcting inaccurate outputs generated by machine learning models.

### Example Workflows Related to Generating Linguistically Calibrated Outputs in Machine Learning Models

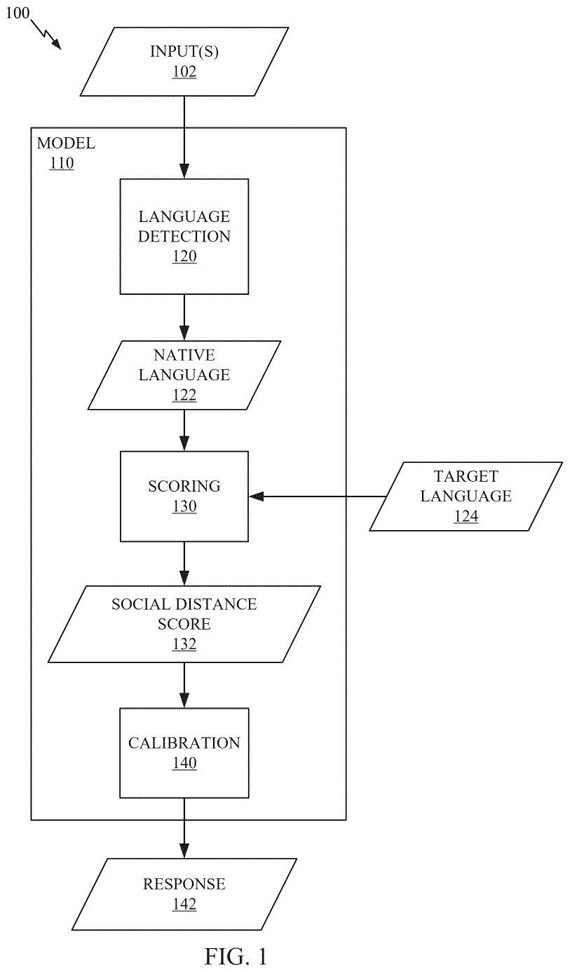

FIG. 1 depicts an example workflow 100 related to generating linguistically calibrated outputs in machine learning models.

A model 110 may comprise a machine learning model. In a particular example, model 110 is a language processing machine learning model such as a large language model (LLM). For example, model 110 may have been trained on a large training data set of natural language text in order to process natural language inputs and generate natural language content in response. In some embodiments, model 110 is a generative pre-trained transformer (GPT) model that has been trained on a large set of training data (e.g., across a plurality of domains), and is capable as a result of such training to perform a wide variety of language-related tasks in response to natural language prompts. In some embodiments, model 110 has been fine-tuned for one or more particular domains, such as for use with a particular software application or for a specific purpose, while in other embodiments model 110 has been trained in a more general fashion and has not been fine-tuned in such a manner. Model 110 may have a large number of tunable parameters, which are iteratively adjusted during a model training process based on training data. In alternative embodiments, model 110 may be another type of machine learning model that is capable of generating content. For example, model 110 may be a generative adversarial network (GAN), an autoencoder model, an autoregressive model, a diffusion model, a Bayesian network, a hidden Markov model, and/or the like.

The model 110 may receive one or more input(s) 102. The input(s) 102 may contain natural language in written form, oral form, or both. The input(s) 102 may be in a target language, for instance, English. Additionally, the input(s) could be, in whole or in a part, an email message, instant message, voice note, voice or text from one or more elements of a software application, and/or the like. The model 110, during language detection 120, may detect a native language 122 of a user based on the input(s) 102 which are in the target language 124. For example, the machine learning model may be trained to identify linguistic patterns and features indicative of a user's native language, such as syntax, vocabulary usage, common errors, and/or other linguistic markers that vary between different native language backgrounds. The accuracy of the detection may be enhanced by using training datasets containing statements in the target language labeled with known native language backgrounds in order to train the machine learning model. If the native language 122 exceeds a particular level of certainty that it is the native language of the user, then it may be passed to scoring 130.

Once the machine learning model has detected the native language 122, it may then determine a social distance score 132 during scoring 130. Scoring 130 comprises comparing one or more attributes associated with the native language 122 to a baseline set of attributes associated with the target language 124. For example, the machine learning model may analyze a geographical proximity between the native language and the target language, a cultural proximity between the native language and the target language, historical relationships between the native language and the target language, linguistic similarity between the native language and the target language, among others. Languages spoken in geographically or culturally close regions may be assigned closer scores. For instance, Mandarin, Cantonese, and other Chinese languages are closer to each other, while languages from different regions, like Chinese and African languages, have larger social distances from one another. Additionally, languages from countries with historical ties, such as a colonial past or shared history, may be assigned closer scores (e.g., Portuguese and Spanish) as well as languages that share linguistic features, such as vocabulary and grammar (e.g., Spanish and Italian).

Based on the social distance score 132, the model 110 may then generate a calibrated response 142 to the input(s) 102 during calibration 140. Generating the calibrated response 142 may comprise generating, in the target language, a standard response to the one or more input(s) 102 and then altering one or more aspects of the response according to characteristics associated with the native language 122 to produce the calibrated response 142. This may include making adjustments to the clarity of the response, such as simplifying language when the social distance score is high (i.e., to make the response easier to understand) or to the style of the response, such as maintaining similar style when the social distance score is low (i.e., keeping the response in a style the user may already be familiar with). It may also include incorporating cultural nuances and context, reducing idiomatic and figurative language (e.g., for native languages with higher social distance scores), providing more explanation for technical terminology, modifying the use and frequency of formalities (e.g., based on cultural expectations), and including examples and/or analogies for ease of understanding. Any number of the aforementioned strategies may be combined and implemented during calibration 140. For example, a certain calibrated response may be generated by simplifying language, explaining a technical term, and removing an idiom, while another may be generated by altering a phrase to include a formality and an extra example to further clarify a particular concept. An additional example is provided below wherein a phrase is altered to clarify its meaning for an individual whose first language is not English:
Thank you for your message. Yes, we can arrange the contract signing for tomorrow. We will review the terms of the contract and go over the details, paying particular attention to the details and scope of the work.
Thank you for your message. Yes, we can arrange the contract signing for tomorrow. We will review the terms of the contract and go over the details, especially focusing on the specifics and scope of the work.

The calibrated response 142 may then be provided as an output. If, for example, the model 110 detects the native language 122 to be the same as the target language (e.g., the input was in English and the user is a native English speaker), then the standard response (i.e., with no alterations) may be provided as the output. An action may be performed based on the output, such as displaying the output via a user interface, sending the output to one or more elements of a software application for further processing, or both.

It is noted that language detection 120, scoring 130, and calibration 140 may be performed based on a prompt that is provided to model 110 along with input(s) 102. For example, the prompt may include natural language instructions that instruct model 110 to perform language detection 120, scoring 130, and calibration 140, and to output the calibrated response (e.g., response 142).

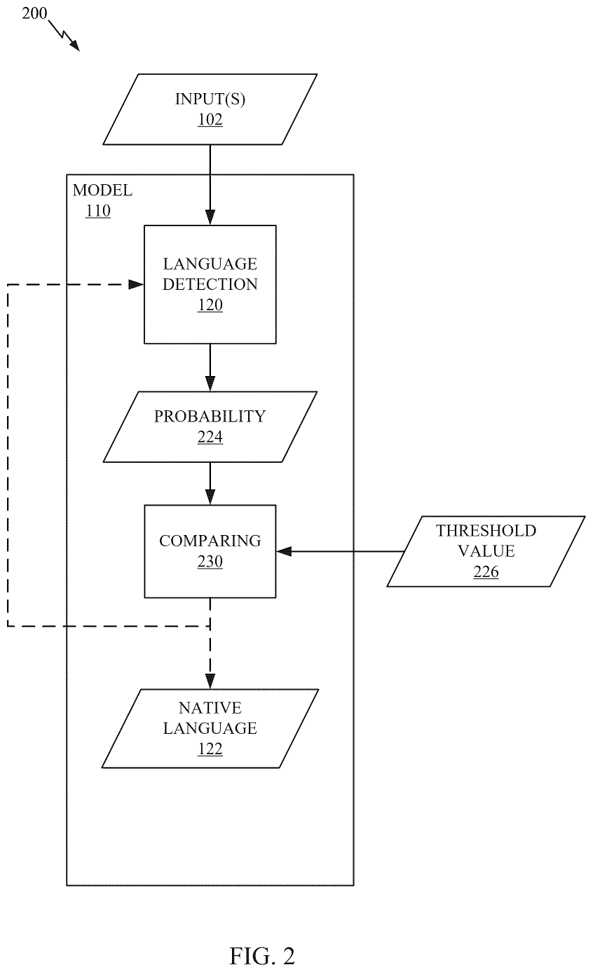

FIG. 2 depicts an additional example workflow 200 related to generating linguistically calibrated outputs in machine learning models. For example, workflow 200 depicts a series of intermediate steps associated with determining and analyzing the probability associated with the native language during the detection process that may be performed by the model 110 in FIG. 1.

During language detection 120, the model 110 may, as part of detecting a native language 122, generate a probability associated with one or more potential native languages. For example, when evaluating the input(s) 102, the machine learning model may determine that the native language of the user is 82% likely to be Spanish, 13% likely to be Portuguese, and 5% likely to be Italian. An additional example is provided below:

```
“native language”: [
    {
    “value”: “Armenian”,
    “Percentage”: 70,
    “Reason”: “The narrative contains references to
    Armenian history, culture, and names, suggesting a
    strong Armenian background.”
  },
  {
    “value”: “Turkish”,
    “Percentage”: 20,
    “Reason”: “The narrative mentions locations in
    modern-day Turkey and uses some Turkish place
    names.”
  },
  }
    “value”: “English”,
    “Percentage”: 10,
    “Reason”: “The narrative is written in English,
    though with some grammatical errors and non-native
    structures.”
  }
]
```

The model 110 may then compare the one or more probabilities to a threshold value 226 provided the model 110. If, for instance, the probability 224 of a native language 122 is greater than the threshold value 226, then the native language 122 is passed to the next step in the system (i.e., generating the social distance score 132 during scoring 130 in FIG. 1). In the preceding example, a threshold value of 80% (e.g., the threshold may be configurable) would result in Spanish being selected as the native language 122 and passed to scoring 130. If, however, the probability 224 of each native language is less than the threshold value 226, then a native language 122 is not determined nor passed to scoring 130. Alternative actions may include re-processing the input(s) 102 through detection 120 and comparing 230, providing the user with a notification, or a combination thereof. This allows for increased accuracy and efficiency by ensuring only a native language with a requisite level of certainty is passed on and used to generate the calibrated input.

It is noted that the generation of probabilities associated with native languages (e.g., including probability 224) at language detection 120, and comparing 230, may be performed based on a prompt provided to model 110 (e.g., the same prompt that was provided to model 110 instructing the model 110 to perform language detection 120, scoring 130, and calibration 140 of FIG. 1).

Example Block Diagram Related to Generating Linguistically Calibrated Outputs in Machine Learning Models

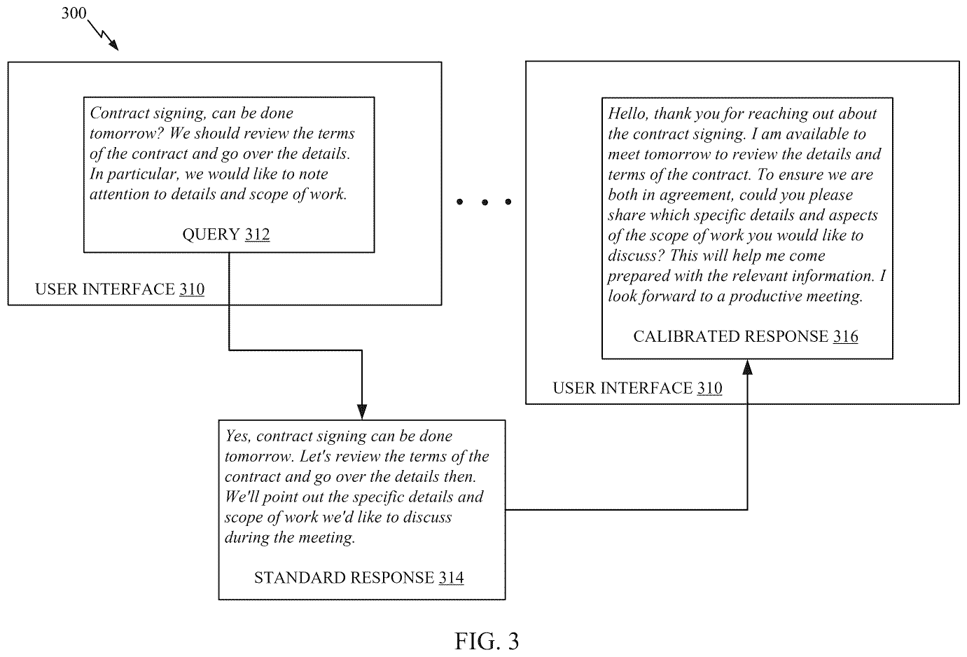

FIG. 3 depicts a block diagram illustrating an example related to generating linguistically calibrated outputs in machine learning models. For example, block diagram 300 may represent a user input and a subsequent calibrated response generated by one or more steps described with respect to FIG. 1 and/or FIG. 2 and displayed on a user interface 310 (e.g., associated with a computing application running on a computing device).

A user may provide, via a user interface 310, one or more inputs to be processed by the machine learning model. As stated above, this can include text or voice from an email message, text message, chat window, and/or an element of a software application, among others. For example, the user could be sending a message though a website's “Contact Us” feature asking a query 312 regarding a contract with a contractor they had hired. As described with respect to FIG. 1 and FIG. 2, a standard response 314 may be generated by the machine learning model and then altered according to one or more characteristics associated with the user's native language that was detected by the machine learning model to create a calibrated response 316. The calibrated response 316 may then be displayed back to the user via the user interface 310. Notably, the calibrated response 316 differs from the standard response 314 in tone, syntax, and vocabulary, providing a more personalized response to the user that addresses the substance of their query 312 but in a way that increases the user's understanding of and overall satisfaction with the response, which is key across a variety of personal and/or business relationships. In other examples, responses could be calibrated to be direct and efficient with a focus on precision, could emphasize politeness and provide structured explanations, could emphasize clarity and respect, could include particular terminology and/or grammatical structure(s), and/or could comprise other similar combinations depending on the native language of the user.

### Example Operations Related to Generating Linguistically Calibrated Outputs in Machine Learning Models

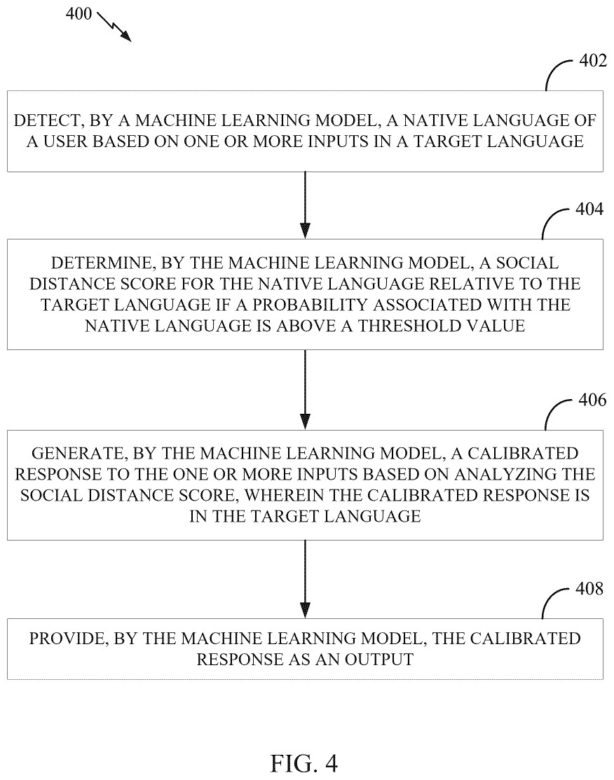

FIG. 4 depicts example operations 400 related to generating linguistically calibrated outputs in machine learning models. For example, operations 400 may be performed by one or more of the components described with respect to FIG. 1, FIG. 2, and/or FIG. 3.

Operations 400 begin at step 402 with detecting, by a machine learning model, a native language of a user based on one or more inputs in a target language. Certain embodiments provide that the one or more inputs comprise one or more of: a written representation of language; or an oral representation of language. According to other embodiments, the native language comprises one or more of: a language different than the target language; a dialect; or a hybrid language. In some embodiments, the detecting of the native language of the user from the one or more inputs further comprises generating, by the machine learning model, a probability associated with the native language.

Operations 400 continue at step 404 with determining, by the machine learning model, a social distance score for the native language relative to the target language if a probability associated with the native language is above a threshold value. According to certain embodiments, the determining of the social distance score for the native language relative to the target language if the probability associated with the native language is above the threshold value comprises comparing one or more attributes associated with the native language to a baseline set of attributes associated with the target language. Some embodiments provide that the comparing of the one or more attributes associated with the native language to the baseline set of attributes associated with the target language comprises analyzing one or more of: a geographical proximity between the native language and the target language; a cultural proximity between the native language and the target language; historical relationships between the native language and the target language; or linguistic similarity between the native language and the target language.

Operations 400 continue at step 406 with generating, by the machine learning model, a calibrated response to the one or more inputs based on analyzing the social distance score, wherein the calibrated response is in the target language. According to some embodiments, the generating of the calibrated response to the one or more inputs based on the analyzing of the social distance score comprises generating a response to the one or more inputs and altering one or more aspects of the response according to characteristics associated with the native language to produce the calibrated response.

Operations 400 continue at step 408 with providing, by the machine learning model, the calibrated response as an output.

In certain embodiments, the method further comprises performing an action based on the output, wherein the performing of the action comprises one or more of: displaying the output via a user interface or sending the output to one or more elements of a software application.

### Example of a Processing System for Generating Linguistically Calibrated Outputs in Machine Learning Models

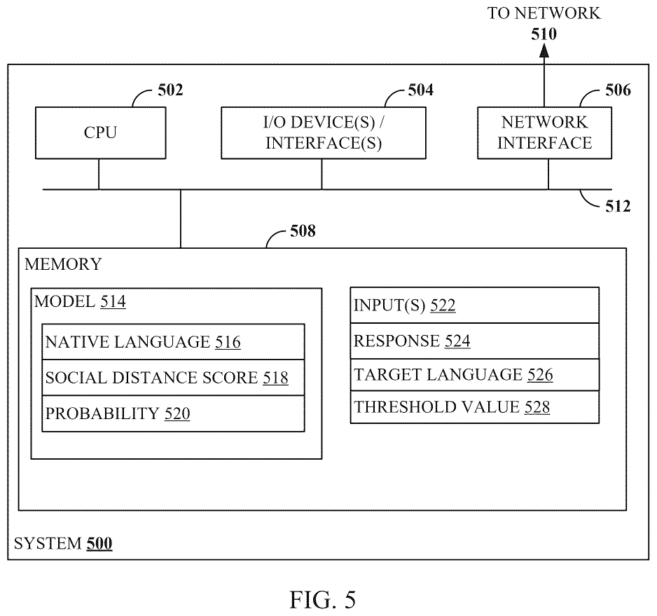

FIG. 5 illustrates an example system 500 with which embodiments of the present disclosure may be implemented. For example, system 500 may be configured to perform operations 400 of FIG. 4 and/or to implement one or more components as in FIG. 1, FIG. 2, or FIG. 3.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 408, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes model 514, native language 516, social distance score 518, and probability 520. Model 514 may be representative of model 110 of FIG. 1 and FIG. 2. Native language 516 may be representative of native language 122 of FIG. 1 and FIG. 2. Social distance score 518 may be representative of social distance score 132 of FIG. 1. Probability 520 may be representative of probability 224 of FIG. 2.

Memory 508 further comprises input(s) 522 which may correspond to input(s) 102 of FIG. 1 and FIG. 2. Memory 508 further comprises response 524, which may correspond to response 142 of FIG. 1. Memory 508 further comprises target language 526, which may correspond to target language 124 of FIG. 1. Memory 508 further comprises threshold value 528, which may correspond to threshold value 226 of FIG. 2. It is noted that in some embodiments, system 500 may interact with one or more external components, such as via network 510, in order to retrieve data and/or perform operations. Furthermore, techniques described herein may be implemented via more or fewer components than those shown and described with respect to FIG. 5, such as on one or more computing systems.

### ADDITIONAL CONSIDERATIONS

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for generating linguistically calibrated outputs in machine learning models, comprising:
detecting, by a machine learning model, a native language of a user based on one or more inputs in a target language;
determining, by the machine learning model, a social distance score for the native language relative to the target language if a probability associated with the native language is above a threshold value;
generating, by the machine learning model, a calibrated response to the one or more inputs based on analyzing the social distance score, wherein the calibrated response is in the target language; and
providing, by the machine learning model, the calibrated response as an output.

2. The method of claim 1, wherein the one or more inputs comprise one or more of:
a written representation of language; or
an oral representation of language.

3. The method of claim 1, wherein the native language comprises one or more of:
a language different than the target language;
a dialect; or
a hybrid language.

4. The method of claim 1, wherein the detecting of the native language of the user from the one or more inputs further comprises generating, by the machine learning model, the probability associated with the native language.

5. The method of claim 1, wherein the determining of the social distance score for the native language relative to the target language if the probability associated with the native language is above the threshold value comprises comparing one or more attributes associated with the native language to a baseline set of attributes associated with the target language.

6. The method of claim 5, wherein the comparing of the one or more attributes associated with the native language to the baseline set of attributes associated with the target language comprises analyzing one or more of:
a geographical proximity between the native language and the target language;
a cultural proximity between the native language and the target language;
historical relationships between the native language and the target language; or
linguistic similarity between the native language and the target language.

7. The method of claim 1, wherein the generating of the calibrated response to the one or more inputs based on the analyzing of the social distance score comprises generating a response to the one or more inputs and altering one or more aspects of the response according to characteristics associated with the native language to produce the calibrated response.

8. The method of claim 1, further comprising performing an action based on the output, wherein the performing of the action comprises one or more of:
displaying the output via a user interface; or
sending the output to one or more elements of a software application.

9. A system for generating linguistically calibrated outputs in machine learning models, comprising:
one or more processors; and
a memory comprising instructions that, when executed by the one or more processors, cause the system to:
detect, by a machine learning model, a native language of a user based on one or more inputs in a target language;
determine, by the machine learning model, a social distance score for the native language relative to the target language if a probability associated with the native language is above a threshold value;
generate, by the machine learning model, a calibrated response to the one or more inputs based on analyzing the social distance score, wherein the calibrated response is in the target language; and
provide, by the machine learning model, the calibrated response as an output.

10. The system of claim 9, wherein the one or more inputs comprise one or more of:
a written representation of language; or
an oral representation of language.

11. The system of claim 9, wherein the native language comprises one or more of:
a language different than the target language;
a dialect; or
a hybrid language.

12. The system of claim 9, wherein the detecting of the native language of the user from the one or more inputs further comprises generating, by the machine learning model, the probability associated with the native language.

13. The system of claim 9, wherein the determining of the social distance score for the native language relative to the target language if the probability associated with the native language is above the threshold value comprises comparing one or more attributes associated with the native language to a baseline set of attributes associated with the target language.

14. The system of claim 13, wherein the comparing of the one or more attributes associated with the native language to the baseline set of attributes associated with the target language comprises analyzing one or more of:
a geographical proximity between the native language and the target language;
a cultural proximity between the native language and the target language;
historical relationships between the native language and the target language; or
linguistic similarity between the native language and the target language.

15. The system of claim 9, wherein the generating of the calibrated response to the one or more inputs based on the analyzing of the social distance score comprises generating a response to the one or more inputs and altering one or more aspects of the response according to characteristics associated with the native language to produce the calibrated response.

16. The system of claim 9, wherein the instructions, when executed by the one or more processors, further cause the system to perform an action based on the output, wherein the performing of the action comprises one or more of:
displaying the output via a user interface; or
sending the output to one or more elements of a software application.

17. A non-transitory computer readable medium comprising instructions that, when executed by one or more processors of a computing system, cause the computing system to:
detect, by a machine learning model, a native language of a user based on one or more inputs in a target language;
determine, by the machine learning model, a social distance score for the native language relative to the target language if a probability associated with the native language is above a threshold value;
generate, by the machine learning model, a calibrated response to the one or more inputs based on analyzing the social distance score, wherein the calibrated response is in the target language; and
provide, by the machine learning model, the calibrated response as an output.

18. The non-transitory computer readable medium of claim 17, wherein the one or more inputs comprise one or more of:
a written representation of language; or
an oral representation of language.

19. The non-transitory computer readable medium of claim 17, wherein the native language comprises one or more of:
a language different than the target language;
a dialect; or
a hybrid language.

20. The non-transitory computer readable medium of claim 17, wherein the detecting of the native language of the user from the one or more inputs further comprises generating, by the machine learning model, the probability associated with the native language.
